(19) United States
(12) Patent Application Publication
(10) Pub. No.: US 2006/0063592 A1
(43) Pub. Date: Mar. 23, 2006

(54) Electronic medal

(75) Inventors: Mordechai Teicher, Hod Hasharon (IL); Eyal Bychkov, Hod Hasharon (IL); Shay Eliyahu, Tel Aviv (IL)

Correspondence Address: DR. MARK FRIEDMAN LTD.;C/o Bill Polkinghorn, 9003 Florin Way, Upper Marlboro, MD, 20772, US

(73) Assignee: M-SYSTEMS FLASH DISK PIONEERS, LTD.

(21) Appl. No.: 11/191,915

(22) Filed: Jul. 29, 2005

Related U.S. Application Data
(60) Provisional application No. 60/610,994, filed on Sep. 20, 2004.

(51) Int. Cl. A63F 13/00

(52) U.S. Cl. 463/30

(57) ABSTRACT

A medal includes an interface for receiving, from a game machine, the score of a player of the game, and also a display mechanism for displaying the score visually and/or audibly when the medal is operationally disconnected from the game machine. The display mechanism may include a screen for displaying the score visually and/or a speaker for displaying the score audibly. The display mechanism may be integral with a housing of the interface and of a memory that stores the score, or may be reversibly operationally attachable to the housing.

This patent application claims the benefit of U.S. Provisional Patent Application No. 60/610,994, filed Sep. 20, 2004

### FIELD AND BACKGROUND OF THE INVENTION

The present invention relates to portable electronic displays, and in particular to such a display for exhibiting the performance of player of an electronic game.

Many kinds of games are accomplishment-driven: the player either competes against others or aims at reaching a high score within a predefined scale. Those who win games or reach a high score are proud of their achievements and wish to exhibit them to others. In sports games winners are crowned with medals, trophies or framed certificates. In other games there are often scoreboards that exhibit the names of the winners and their scores.

Electronic games have become commonplace. These games appear in many forms such as handheld devices, dedicated computers, software for general-purpose computers, and commercial machines for game arcades. Some games are for a single player who aims at a high score, while other games are for two or more players competing with each other, locally or through a communication network such as the Internet or a cellular telephony network. Some electronic game machines cooperate with detachable personal game cards, which allow the game player to port the current game status from one game machine to another.

While the players or attendees in an electronic game may be impressed by the accomplishments of a player, it is hard to impress others who do not attend. The notion of medals, trophies and framed certificates is thus missing in the realm of electronic games.

There is thus a widely recognized need for, and it would be highly advantageous to have, a medal that a player of an electronic game can use to boast of his/her prowess to those who didn't watch the game.

### SUMMARY OF THE INVENTION

By “game machine” or “machine” is meant a computerized device, such as a dedicated computer, a general-purpose computer or a computerized portable appliance, programmed for executing a game for a player or a plurality of players. A game machine can include visual, audio and/or mechanical user interfaces, as well as communication means for interfacing with game machines of other players and/or with central game servers.

By “electronic game” or “game” is meant any performance-driven electronic game, executed through a game machine.

By “player” or “gamer” is meant a participant in an electronic game.

By “accomplishment”, “achievement” or “performance” is meant a measurable result for a player of a game.

By “scoring” or “score” is meant a measurement of a player's performance in a session of a game, or in multiple sessions of a game. The performance can be measured in absolute terms (e.g. ‘800 points’, ‘17 seconds’, ‘52 centimeters’, etc.), or relative terms (e.g. ‘first place’, ‘second place’, etc.). A game may involve competition among teams, and then a player's achievement can be, for example, ‘a member of the winning team’. Combinations are also possible, for example: ‘second winner—17 seconds’.

By “game card” is meant a portable device that is reversibly attached to a game machine and that records game status information. A game card allows a player to suspend playing and to resume playing later from the point of interruption, at the same game machine or at a different game machine.

By “electronic medal” or “medal” is meant a device that is separate or separable from a game machine, that can electronically receive a score from the machine, and that can exhibit the score through visual and/or audio signals. A medal can have the form factor of a large coin like conventional medals, a pendant of any shape and size that is conveniently wearable, an electronic screen to be carried like a wallet or hung on a wall like a framed picture, a trophy of any size and shape, and so forth.

The present invention seeks to provide electronic medals for players of electronic games. A medal can be exhibited by a player as a proof of his or her performance in an electronic game.

According to the present invention there is provided a medal including: (a) an interface for receiving, from a game machine, a score of a user who plays a game using the game machine; and (b) a display mechanism for displaying the score when the interface is operationally disconnected from the game machine.

According to the present invention there is provided a game system including: (a) a game machine; and (b) a medal including: (i) an interface for receiving, from the game machine, a score of a user who plays a game using the game machine, and (ii) a display mechanism for displaying the score when the interface is operationally disconnected from the game machine.

According to the present invention there is provided a method of playing a game on a game machine, including the steps of: (a) computing a score of the game, by the game machine; (b) transmitting the score to a medal, by the game machine; and (c) displaying the score on the medal while the medal is operationally disconnected from the game machine.

The present invention is a medal for displaying the score of a user of a game machine. The basic medal of the present invention includes an interface for receiving the score directly or indirectly from a game machine and a display mechanism for displaying the score when the interface is operationally disconnected from the game machine.

Preferably, the display mechanism includes a screen for displaying at least a portion of the score visually. More preferably, the display mechanism includes a connector for reversibly operationally connecting the display mechanism to the medal. Most preferably, the medal includes a plurality of such display mechanisms, each display mechanism being for a respective game. Optionally, the screen is persistent. Also optionally, the display mechanism includes a speaker for displaying at least a portion of the score audibly.

Preferably, the medal includes a memory for storing the score and a housing for the interface and the memory.

In some more preferred embodiments of the medal, the display mechanism is integral with the housing, which means that the display mechanism is housed within the housing and/or forms part of the housing itself. In other more preferred embodiments of the medal, the display mechanism is reversibly operationally connectable to the housing. The embodiments with reversibly operationally connectible display mechanisms preferably include pluralities of such display mechanisms, each such display mechanism being for a different respective game. Most preferably, each such display mechanism includes an identifier of its respective game, and the medal also includes a controller for comparing the identifier, of the display mechanism currently operationally connected to the housing, to contents of the memory in order to display the score of that display mechanism's game.

A game system of the present invention includes the game machine and the medal. Preferably, the game machine also includes a game program for playing the game, computing the score and transmitting the score to the medal. Most preferably, the game program also is for transmitting a status of the game to the medal, thereby enabling the medal to function as a game card for the game.

The basic method of the present invention is for playing a game on a game machine. The game machine computes a score of the game and transmits the score to a medal. The score is displayed on the medal while the medal is operationally disconnected from the game machine. Preferably, the game machine also transmits a status of the game to the medal.

### BRIEF DESCRIPTION OF THE DRAWINGS

The invention is herein described, by way of example only, with reference to the accompanying drawings, wherein:

FIGS. 1, 2 and 3 are schematic block diagrams of three different preferred embodiments of the present invention;

FIG. 4 is a schematic block diagram of a replaceable display;

FIG. 5 illustrates a display screen;

FIG. 6 is a flow chart of the operation of the embodiments of FIGS. 1-3;

FIG. 7 is a flow chart of the operation of a medal that includes the replaceable display of FIG. 4;

FIG. 8 is a schematic block diagram of an embodiment of the present invention that includes a persistent display.

### DESCRIPTION OF THE PREFERRED EMBODIMENTS

The present invention is of an electronic medal that can be used to advertise prowess in playing electronic games.

The principles and operation of an electronic medal according to the present invention may be better understood with reference to the drawings and the accompanying description.

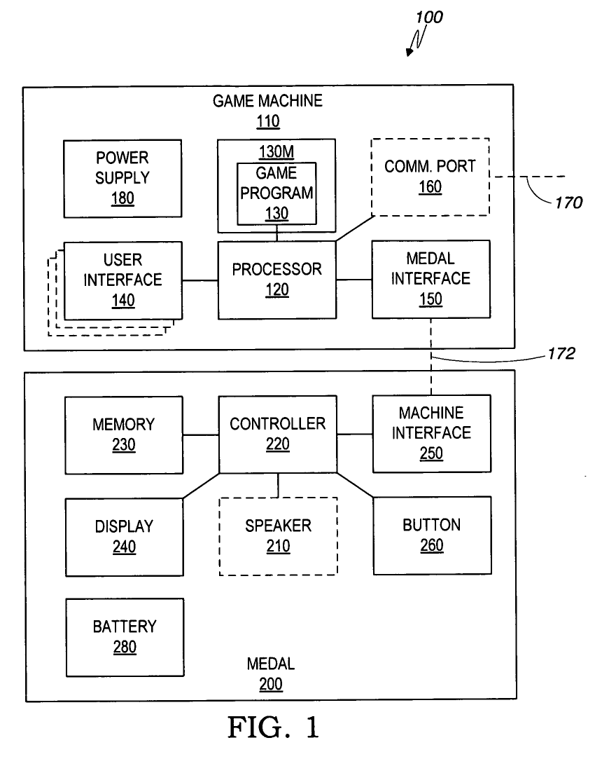

Reference is made to FIG. 1, which is a high-level schematic block diagram of a first preferred embodiment 100 of the present invention, wherein a standalone medal 200 is connectable to a game machine 110. A game machine 110 is a computerized device of any suitable form factor, such as a general-purpose personal computer of any size, a dedicated personal game computer of any size, or a commercial game machine for game arcades. A game program 130 in a non-volatile memory 130M includes executable code that runs on a processor 120 to execute the game, which interfaces with a user through a user interface 140 that includes visual, audio and/or mechanical interfaces (e.g. a vibrating joystick or an accelerating platform) to receive user commands and to respond with the game experience. An optional communication port 160 and a communication link 170 allow communication with other game machines for multi-player games, and/or with centralized game servers for downloading games or competing against a virtual player. All the elements described so far are well known in the art. The present invention adds to game machine 110 two novel elements. Game program 130 adds medal scoring functionality, and medal interface 150 outputs the score to medal 200. A medal interface 150 includes mechanical elements to receive a medal 200 and an electrical interface to communicate with medal 200 through a wired or wireless link 172. A power supply 180 energizes the other components of game machine 110.

Medal 200 has a form factor that, on the one hand, is convenient to connect to game machine 110, and on the other hand is presentable as a medal. Examples of such a form factor include a USB key (in which case link 172 uses the USB protocol). a memory card (in which case link 172 uses protocols such as CompactFlash™, SmartMedia™; MemoryStick™, SecureDigita™1 or MultimediaCard™), or a shape such as a large coin, trophy or framed certificate (in which case link 172 preferably uses a wireless protocol over an RF or infrared link). A machine interface 250 matches medal interface 150 and link 172 to provide mechanical, electrical and logical coupling between medal 200 and game machine 110, to execute the functionalities of the present invention as described below. A non-volatile memory 230 stores the score received from game machine 110 via machine interface 250 and a controller 220 of memory 230. Controller 220 writes the score received from game machine 110 into memory 230. Later, when medal 200 is separated from game machine 110, controller 220 retrieves the score from memory 230 and exhibits the score on a display 240 and optionally also through speaker 210. Display 240 is electronically-controlled by controller 220 to exhibit the score stored in memory 230, using display technologies such as liquid crystal (LCD) with or without back light, light emitting diodes (LED), electrolunincent (EL) elements, or backlit transparencies. Display 240 optionally and preferably also includes preset decorative symbols to attract attention and to improve the appearance of medal 200. If medal 200 is specific to one game only, for example, if medal 200 is provided as part of the game package of game machine 110 or game program 130, then display 240 preferably includes preset symbols for identifying the related game. An optional speaker 210 adds sound effects appropriate to the score shown on display 240. A button 260 is preferably included to switch medal 200 on and off to conserve battery power, as well as to switch between different games in the case that medal 200 serves more than one game. A battery 280 energizes the other relevant components of medal 200 described above.

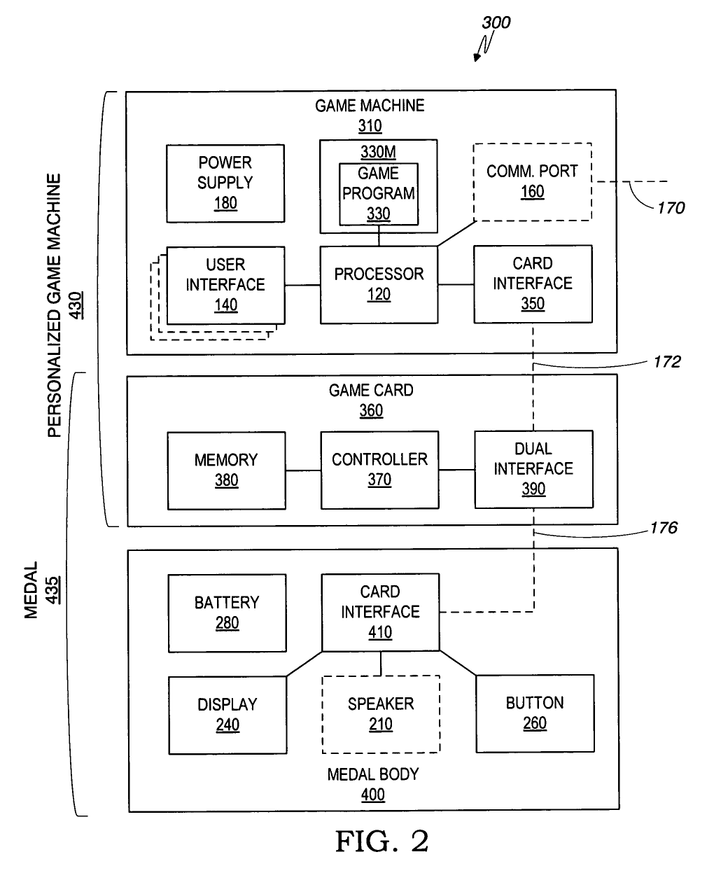

FIG. 2 is a high-level schematic block diagram of a second preferred embodiment 300 of the present invention, for the specific case in which a game machine 310 cooperates with a detachable game card 360. In embodiment 300, power supply 180, communication port 160, link 170, link 172, user interface 140 and processor 120 are similar to those of game machine 110 of FIG. 1. Game program 330 in non-volatile memory 330M includes similar functionalities to those of game program 130 of FIG. 1, except that game scores and other game status information are now recorded through a card interface 350 and a link 172 onto a game card 360 instead of to medal 200 of FIG. 1.

Game card 360 carries in a non-volatile memory 380 personal game status information, which allows a player to suspend playing, and resume playing later, from the point of interruption, at the same or another machine. Additionally, in accordance to the present invention, memory 380 also includes the player's score, provided by processor 120 under game program 330 via card interface 350 and link 172. A controller 370 serves to write and read data to and from memory 380. A dual interface 390 serves to selectively connect game card 360 to either game machine 310 via link 172, or to a medal body 400 via a link 176. Links 172 and 176 can use the same technology, for example USB, or different technologies, for example link 172 may use RF for both data transfer and energizing game card 360, while link 176 may use a CompactFlash interface for similar purposes with respect to medal body 400. When game card 360 is connected to game machine 310, game card 360 and game machine 310 together form a personalized game machine 430 that personalizes the game starting point, status data and score recording, respective to the gamer who owns game card 360.

Medal body 400 is designed to receive game card 360 for forming a medal 435. For this purpose game card 360 is disconnected from game machine 310, and at any time afterwards, game card 360 is connected to medal body 400 by dual interface 390 interfacing with card interface 410 via link 176. The mutual interface includes mechanical, electrical and logical connections to make medal 435 a unified item that functions as a medal in accordance with the present invention. Thus, the score of the player is retrieved from memory 380 by controller 370 and sent to display 240 via dual interface 390, link 176 and card interface 410. Display 240, speaker 210, battery 280 and button 260 function similarly to their counterparts in FIG. 1. It will be noted that in the exemplary preferred embodiment of FIG. 2, medal 435 has a single controller 370 provided in game card 360, and a single battery 280 provided in medal body 400. In alternative designs, depending also on the specifics of the technologies of display 240 and memory 380, a controller can be added to medal body 400 and possibly removed from game card 360; similarly, a battery can be included in game card 360 instead of or in addition to battery 280 of medal body 400.

Medal body 400 thus is an example of the reversibly operationally connectable display mechanism that is recited in the appended claims. Card interface 410 is a connector for reversibly operationally connecting medal body 400 to game card 360 at dual interface 390. Card interface 410 also receives indirectly from game machine 310, via game card 360, scores to be displayed on display 240.

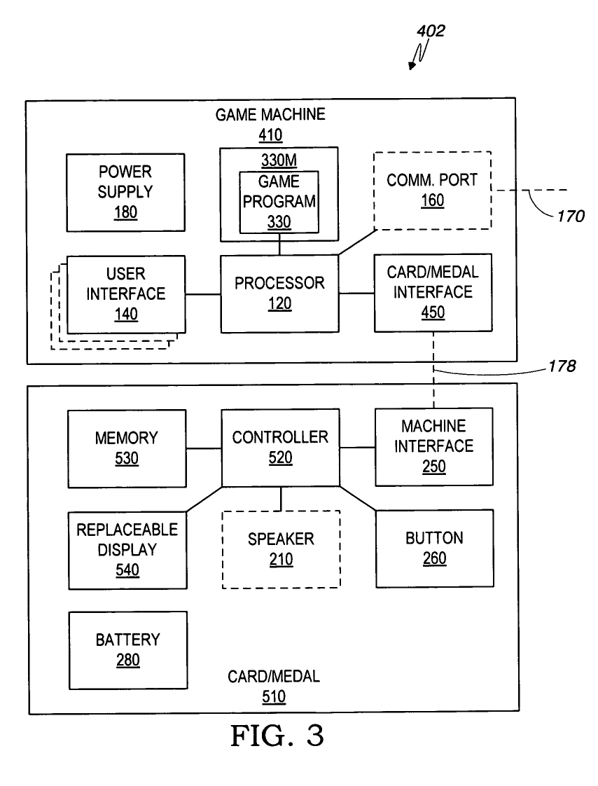

FIG. 3 is a high-level schematic block diagram of a third preferred embodiment 402 of the present invention. Embodiment 402 is a hybrid between the embodiments of FIGS. 1 and 2. In Embodiment 402, a card/medal unit 510 integrates the functionalities of both medal 200 of FIG. 1 and game card 360 of FIG. 2. A game machine 410 includes processor 120, user interface 140, communication port 160 and communication link 170 similar to those of game machine 110 of FIG. 1, and also game program 330 in non-volatile memory 330M as in game machine 310 of FIG. 2, i.e. with both game card and medal functionalities. A card/medal interface 450, machine interface 250 and a link 178 provide mechanical, electrical and logical interfaces for the cooperation of game machine 410 and card/medal unit 510, when card/medal unit 510 is connected to game machine 410. A memory 530 records both game status and score received from game machine 410, and sends game status to game machine 410 as needed, primarily upon connection or reconnection to a game machine 410 after a game has been suspended. A controller 520 serves to write and read data to and from memory 530. It will be noted that card/medal 510 can be connected to one or more game machines 410 during the same game, and may serve a plurality of games to be stored in memory 530. Thus memory 530 may store the status and scores of one or more games played by the owner of card/medal 510 in one or more game machines 410.

When card/medal 510 is disconnected from game machine 410, controller 520 is operable under a user command, received via button 260, to retrieve the user score from memory 530 and to display the score on a replaceable display 540, as described above with respect to display 240 of FIG. 1, and also optionally to generate sound effects from speaker 210 as described above. If memory 530 contains the scores of several games, then button 260 is preferably operable also to select the specific game whose score is to be exhibited by card/medal 510. Battery 280 energizes the other components of card/medal unit 510.

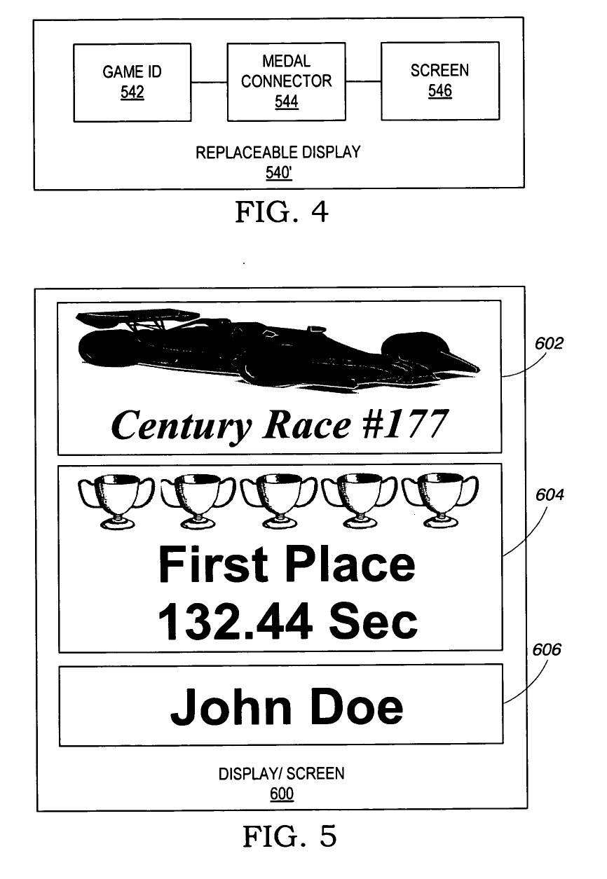

While replaceable display 540 can be identical to display 240 of FIG. 1 or 2, there are advantages to making replaceable display 540 as a replaceable skin. Such a replaceable skin is an example of the mechanically flexible display screen recited in the appended claims. The reason is that the typical game card functionalities known in the art, require a relatively expensive memory 530. It could be costly and/or inconvenient for a user to have a separate card/medal unit 510 for each game program 330 he/she operates. However, to make the medal aspect of unit 510 eye-catching and attractively designed, its display 540 is best customized to game program 330. It is advantageous, therefore, to provide a replaceable display 540, which is supplied with a CD or DVD bearing game program 330, while card/medal unit 510 serves the user for multiple games. Similarly, display 240 of FIGS. 1 and/or 2 can use a replaceable skin, as described herein and in more detail with respect to FIG. 4 below.

Replaceable display 540 also is an example of the reversibly operationally connectable display mechanism that is recited in the appended claims.

Optionally, like controller 520 and memory 530 of card/medal unit 510, controller 220 and memory 230 of medal 200 also include the game card functionalities of controller 370 and memory 380 of game card 360.

In FIG. 1, the rectangle around the components of medal 200 represents a housing that encloses or bears the illustrated components of medal 200. In FIG. 2, the rectangle around the components of game card 360 represents a housing that encloses or bears the illustrated components of game card 360, and the rectangle around the components medal body 400 represents a housing that encloses or bears the illustrated components of medal body 400. In FIG. 3, the rectangle around the components of card/medal 510 represents a housing that encloses or bears the illustrated components of card/medal 510.

FIG. 4 is a high-level schematic block diagram of an instance 540′ of replaceable display 540 of FIG. 3. Replaceable display 540′ includes a screen 546 with all visual elements described with respect to display 240 of FIGS. 1 and 2, as well as a display/screen 600 of FIG. 5 as described below. Replaceable display 540′ also includes a medal connector 544 and a game ID register 542. Medal connector 544 is used for reversibly operationally connecting replaceable display 540′ to card/medal 510 of FIG. 3. Game ID register 542 is a computer-readable electronic circuit that contains a unique identification of the game program 330 associated with the specific replaceable display 540′. Controller 520 checks the correlation between game ID register 542 and the game ID recorded in memory 530, and sends the score respective to game ID 542 to be exhibited on screen 546 of replaceable display 540′ only if the two IDs match.

FIG. 5 is an exemplary illustration of display/screen 600, which applies to any of display 240 of FIG. 1 or 2, or screen 546 of FIG. 4. Panel 602 identifies the game played by the gamer, by illustrative and/or written symbols. If display/screen 600 is used for one game only, as in the example of screen 546 of replaceable display 540′ of FIG. 4, then panel 602 can be preset for the specific game, preferably by using a backlit transparency or customized electroluminescent shapes, which are eye-catching and relatively inexpensive. Alternatively, panel 602 can be based on a backlit LCD, and then become usable for many different games. Panel 604 displays the score of the player in the game identified by panel 602; in the example of FIG. 5, the relative score of ‘first place’ is both written in plain language and represented symbolically by five trophy icons; the measurable absolute performance ‘132.44 Sec’ is also presented. Panel 604 is preferably composed of five backlit transparencies each showing a trophy icon, which can individually be turned on and off by the medal controller 220, 370 or 520, and an LCD or LED pane to show the written information. Panel 606 uses LCD or LED panes for showing the user name, retrieved from memory 230, 380 or 530. It will be appreciated that the division of display/screen 600 into individual panels 602, 604 and 606 is only for the purpose of illustrational clarity, and that actually a single display, such as a backlit LCD display or EL display, can show several or all elements described above.

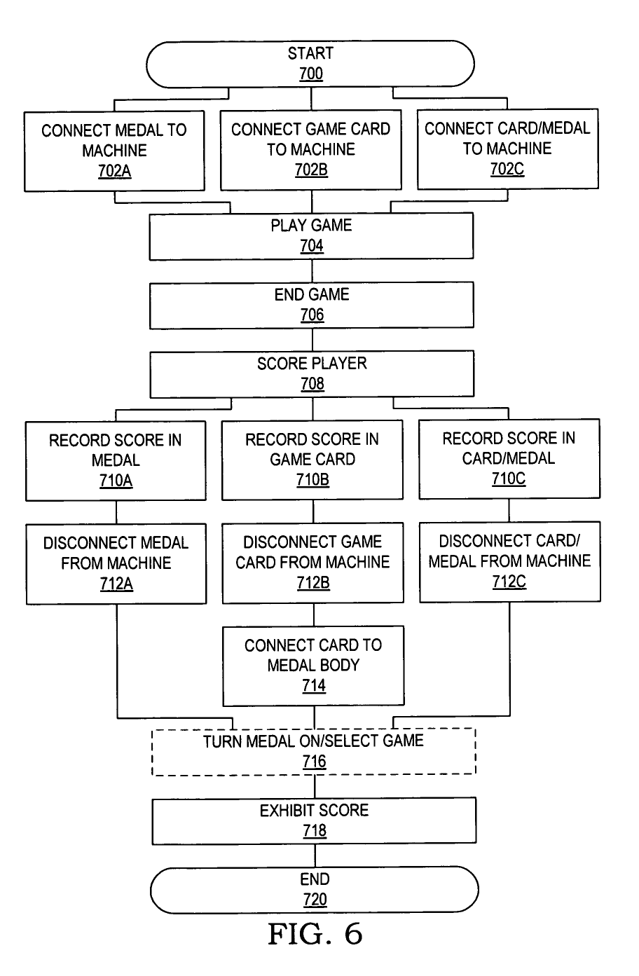

FIG. 6 describes the operation of the preferred embodiments of FIGS. 1-3 above. The following description relates, where applicable, to the embodiments of FIGS. 1/2/3, respectively. The procedure starts in a step 700, by a player approaching a game machine 110/310/410. In a step 702A/B/C, the player connects his medal 200/game card 360/combined medal-game card 510 to the respective game machine; this connection can, in some embodiments, be deferred to anytime before step 710A/B/C. In a step 704 the player plays the game, within one or more sessions of the game, by himself or against other players. In a step 706 the game is ended, and in a step 708 the respective game machine identifies the final score for the player, in relative and/or absolute terms, e.g. ‘First Place, 132.44 Sec’ as in FIG. 6. In a step 710A/B/C the score from step 708 is recorded into the connected medal 200/game card 360/combined medal-game card 510, after which, in a step 712A/B/C the medal 200/game card 360/combined medal-game card 510 is removed from the machine and carried by the user. In a step 714 that relates only to the embodiment of FIG. 2, game card 360 is connected to medal body 400 to form medal 435. In an optional step 716, button 260 is depressed to turn medal 200/435/510 on, and if several games are stored in the respective memory 230/380/530, also to select the game to be exhibited. In a step 718, the game particulars and the score are exhibited by the medal, as described above with respect to the exemplary embodiment of FIG. 5.

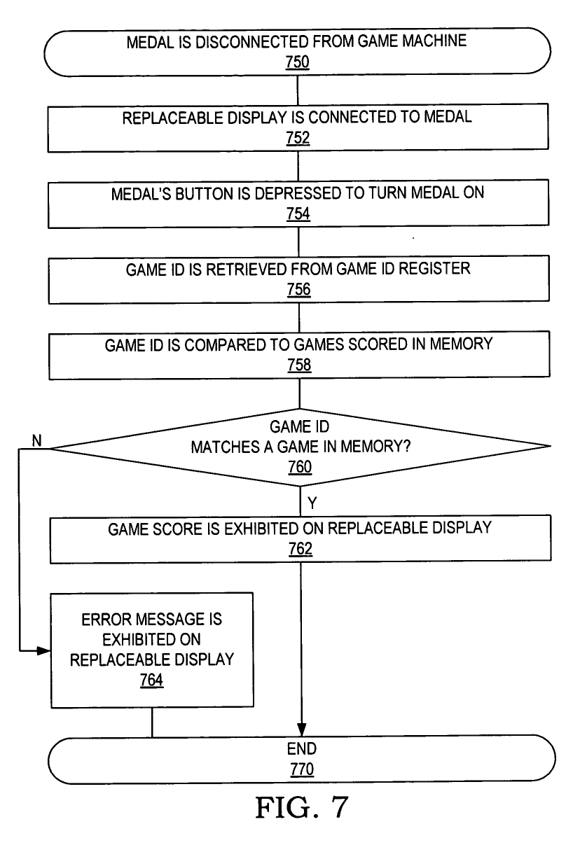

FIG. 7 describes the operation of a medal that has a replaceable display, such as medal 510 of FIG. 3 that has replaceable display 540′ of FIG. 4. The procedure starts in a step 750 upon disconnecting the medal from the respective game machine, which in the present example is game machine 410 of FIG. 3. In a step 752, replaceable display 540′ is connected to medal 510. In a step 754, button 260 of medal 510 is depressed to activate medal 510 for score exhibition. In a step 756, controller 520 retrieves the game ID from game ID register 542 of replaceable display 540′. In a step 758 controller 520 checks the game IDs of all games that have scores stored in memory 530. If any of those IDs matches the game ID retrieved from game ID register 542, then step 760 routes the procedure to step 762, in which the respective score is displayed on screen 546 (FIG. 4); otherwise, the procedure is routed to step 764, which causes screen 546 to display an error message, notifying the user that the specific replaceable display 540′ must match a game for which a score is stored in memory 530. Step 770 ends the procedure.

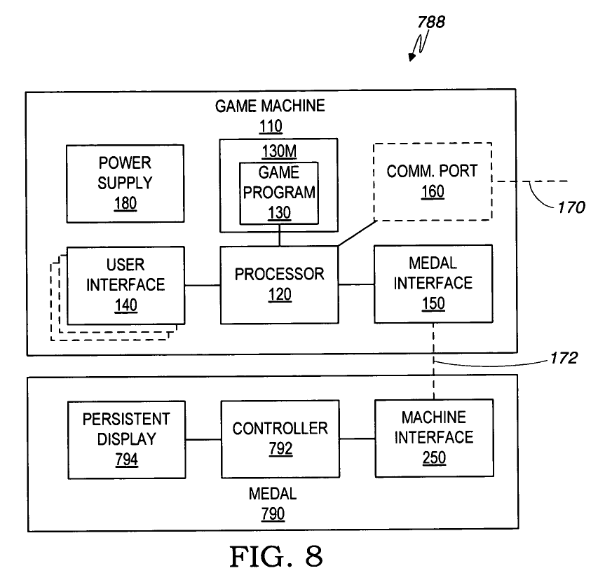

FIG. 8 is a high-level block diagram of another preferred embodiment 788 of the present invention, in which game machine 110, similar to the game machine of FIG. 1, sends the player's score to a medal 790. Medal 790 includes a persistent display 794 operating under the control of a controller 792 to exhibit the user's score. Persistent display 794 includes an electronic display screen that creates an image representing the player's score when medal 790 is connected to game machine 110, and retains this image even after medal 790 is disconnected from game machine 110. Medal interface 150, link 172 and machine interface 250 provide both the score information and the electrical energy needed for the operation of controller 792 and display 794. The display screen of display 794 preferably uses technologies commercially known as “electronic paper” for allowing electronically-created images to be modified when the display is energized, and retain the image after the display is disconnected from a power source. Such technologies are well know in the art, and are covered by numerous patents, including U.S. Pat. No. 5,808,593, U.S. Pat. No. 5,777,782, U.S. Pat. No. 5,767,826, U.S. Pat. No. 5,760,761, U.S. Pat. No. 5,757,345, U.S. Pat. No. 5,751,268, U.S. Pat. No. 5,739,801/U.S. Pat. No. 5,731,792 and U.S. Pat. No. 5,717,515; all of which are incorporated herein by reference.

Non-volatile memories 130M and 330M are examples of a computer-readable storage medium on which is embedded computer-readable code for implementing the game machine functionality required by the present invention.

While the invention has been described with respect to a limited number of embodiments, it will be appreciated that many variations, modifications and other applications of the invention may be made.

What is claimed is:

1. A medal comprising:
(a) an interface for receiving, from a game machine, a score of a user who plays a game using said game machine; and
(b) a display mechanism for displaying said score when said interface is operationally disconnected from said game machine.

2. The medal of claim 1, wherein said display mechanism includes a screen for displaying at least a portion of said score visually.

3. The medal of claim 2, wherein said display mechanism includes a connector for reversibly operationally connecting said display mechanism to the medal.

4. The medal of claim 3, comprising a plurality of said display mechanisms, each said display mechanism being for a different respective said game.

5. The medal of claim 2, wherein said screen is persistent.

6. The medal of claim 1, wherein said display mechanism includes a speaker for displaying at least a portion of said score audibly.

7. The medal of claim 1, further comprising:
(c) a memory for storing said score.

8. The medal of claim 7, further comprising:
(d) a housing for said interface and for said memory.

9. The medal of claim 8, wherein said display mechanism is integral with said housing.

10. The medal of claim 8, wherein said display mechanism is reversibly operationally connectable to said housing.

11. The medal of claim 10, comprising a plurality of said display mechanisms, each said display mechanism being for a different respective said game.

12. The medal of claim 11, wherein each said display mechanism includes an identifier of said respective game of said each display mechanism; and wherein said medal further comprises:
(e) a controller for comparing said identifier, of said display mechanism that is currently operationally connected to said housing, to contents of said memory in order to display said score of said respective game of said display mechanism that is currently operationally connected to said housing.

13. A game system comprising:
(a) a game machine; and
(b) a medal including:
(i) an interface for receiving, from said game machine, a score of a user who plays a game using said game machine, and
(ii) a display mechanism for displaying said score when said interface is operationally disconnected from said game machine.

14. The game system of claim 13, wherein said game machine includes a game program for:
(i) playing said game,
(ii) computing said score; and
(iii) transmitting said score to said medal.

15. The game system of claim 14, wherein said game program also is for:
(iv) transmitting a status of said game to said medal, thereby enabling said medal to function as a game card for said game.

16. A method of playing a game on a game machine, comprising the steps of:
(a) computing a score of the game, by the game machine;
(b) transmitting said score to a medal, by the game machine; and
(c) displaying said score on said medal while said medal is operationally disconnected from said game machine.

17. The method of claim 16, further comprising the step of:
(d) transmitting a status of the game to said medal, by the game machine.
